(19) United States
(12) Patent Application Publication
(10) Pub. No.: US 2026/0357652 A1
(43) Pub. Date: Nov. 12, 2026

(54) INTEGRATED MAGNETIC SCREEN SYSTEM WITH OPTIONAL ZIPPER BUILT INTO SLIDING SCREEN DOOR FRAME

(71) Applicant: Marc Tessier, Bedford, NH (US)

(72) Inventor: Marc Tessier, Bedford, NH (US)

(21) Appl. No.: 19/205,826

(22) Filed: May 12, 2025

(51) Int. Cl. E06B 9/52

(52) U.S. Cl. CPC E06B 9/521; E06B 2009/527

(57) ABSTRACT

An integrated magnetic screen system for sliding screen doors that enables hands-free passage and automatic resealing. The system comprises a vertically and horizontally split mesh screen, vertical magnetic strips and optional bottom magnetic strips for closure, and an optional vertical zipper for access control. Additional optional bottom zippers and reinforced mesh corners provide enhanced durability and sealing. The system is built into or retrofitted onto the sliding screen door frame without impeding the standard operation of the door. It is designed for convenience, insect protection, and flexibility in both residential and light commercial use

### CROSS-REFERENCE TO RELATED APPLICATIONS

This application claims the benefit of U.S. Provisional Patent Application No. 63/803,651, filed on May 10, 2025, the entire contents of which are incorporated herein by reference.

### BACKGROUND OF THE INVENTION

Traditional screen doors require manual operation and often lack flexibility in how access is granted or restricted. Aftermarket magnetic mesh products are common, but they are typically low-quality, externally attached, and do not offer built-in control for children or pets. These mesh panels lack durability, do not integrate into the door frame, and often fall short of homeowners' expectations for appearance and ease of use.

There exists a need for a magnetic screen system that allows hands-free passage, automatic magnetic resealing, and access control via an optional zipper mechanism. The system should be installed as part of the screen door frame—whether integrated at the factory or retrofitted into an existing frame—and provide increased functionality, optional safety, and convenience.

### SUMMARY OF THE INVENTION

The present invention relates to an integrated magnetic walk-through screen system built directly into the frame of a sliding screen door. Unlike temporary mesh curtain solutions, this system is designed to function as a permanent, factory-integrated or retrofit upgrade for sliding doors. The invention enables hands-free passage through a mesh screen that automatically reseals itself via vertically aligned magnetic strips positioned along the central opening seam. In certain embodiments, a vertical zipper (22) may be installed in conjunction with the magnetic seam to provide a secondary closure or locking feature. Additionally, optional bottom zippers (32) may be positioned at the lower edge of the screen to enhance security, sealing capability, or selective access control.

A key feature of the invention is the inclusion of magnets along the bottom edge of the mesh screen to ensure complete closure and prevent insects from entering the home, while also aiding in the automatic realignment of the screen after passage. Additionally, reinforced mesh corners (30) are integrated into the lower edges of the screen to prevent fraying, tearing, or structural fatigue. These corners add durability to high-contact zones and help support the integrity of the vertical magnetic seam.

The system operates without impeding the motion of the adjacent sliding glass door and is compatible with standard frame sizes, allowing for both OEM integration and aftermarket retrofitting.

The invention addresses a widespread need among homeowners and pet owners for a durable, low-maintenance, and visually unobtrusive screen door solution that combines convenience, function, and energy efficiency. The screen system operates independently of the sliding mechanism, allowing the screen door to open and close as it normally would.

### BRIEF DESCRIPTION OF THE DRAWINGS

FIG. 1 illustrates the system as integrated into a sliding screen door frame. The mesh screen (12) is integrated into the screen door frame (14) and forms the primary walk-through surface. The system includes vertical magnetic strips (24) that allow automatic resealing of the central seam, and may include an optional vertical zipper (22) between the magnetic closures. A bottom magnet seal (18) is positioned at the base of each mesh screen. Reinforced mesh corners (30) are shown along the bottom edges of the mesh screen for added durability. Optional bottom zippers (32) are also shown at the lower edges of the mesh screen to provide additional control and sealing. The sliding glass door (26) is adjacent to the screen assembly and includes a door handle (28).

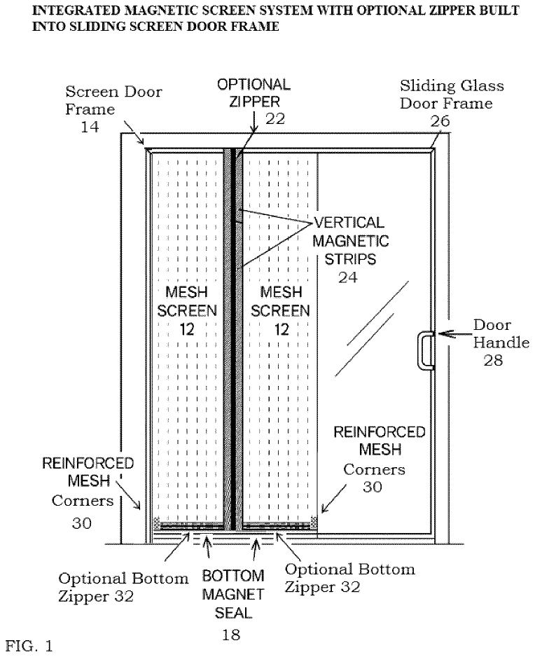

### DETAILED DESCRIPTION OF THE INVENTION

This invention is a built-in walk-through screen system designed to be integrated directly into the frame of a traditional sliding screen door. It is not a temporary or add-on mesh curtain; rather, it is intended as a complete replacement for the standard framed screen door that typically accompanies a sliding glass door.

The invention is envisioned primarily as a built-in screen system that may be included as the default screen option when purchasing a sliding glass door unit from a manufacturer or distributor. However, it may also be produced as a retrofit kit designed to replace or upgrade the screen doors in existing installations.

The system features a durable mesh screen that includes a center vertical seam embedded with magnets. These magnets automatically close and seal the screen after a person or pet walks through, enabling hands-free entry and exit while preventing insects or outdoor debris from entering the home. The magnetic closure is aligned from top to bottom for consistent, automatic resealing.

The screen is split or cut along the bottom by design, with horizontal magnets embedded in the lower edges of the mesh to allow the magnetic closure to function correctly and to ensure the screen can open and reset properly after each use. These magnets provide a complete bottom seal, helping to ensure the screen fully resets after use and prevents pets from inadvertently lifting the edge. Their primary function is to prevent insects from entering the home and to fully seal the bottom mesh screen.

In some variations, a vertical zipper (22) may be added alongside the vertical magnetic seam as a secondary or locking mechanism. In addition, optional bottom zippers (32) may be installed on either or both lower mesh panels to secure the bottom seam or restrict opening as needed. These zippers may provide added security, sealing functionality, or parent/pet control.

1. An integrated magnetic screen system for a sliding screen door frame, comprising: a mesh screen split vertically and horizontally; vertical magnetic strips embedded along opposing inner vertical edges of the mesh screen for automatic self-closing; optional horizontal magnetic strips embedded at the bottom edges of the mesh screen to form a bottom seal; and a screen door frame configured to house the mesh screen as a built-in or retrofit installation.

2. The system of claim 1, further comprising an optional vertical zipper located between the vertical magnetic strips for additional sealing or access control.

3. The system of claim 1, further comprising one or more optional bottom zippers located at the lower edge of the mesh screen.

4. The system of claim 1, wherein the mesh screen includes reinforced mesh corners positioned at the lower corners and optionally at other high-stress areas to prevent tearing and structural fatigue.

5. The system of claim 1, wherein the mesh screen is configured to allow hands-free passage and automatically reseals after use.

6. The system of claim 1, wherein the system is configured to be installed either at the time of manufacture or as a retrofit upgrade to existing sliding screen doors.

7. The system of claim 1, wherein the mesh screen includes pet-safe reinforcement near the bottom edge to resist damage from claws or teeth.

8. The system of claim 1, wherein the magnetic strips are recessed into sewn-in fabric channels to improve durability and aesthetic appeal.

9. The system of claim 1, wherein the screen includes optional side reinforcement rods or tension bands to maintain shape and resist wind displacement.

10. The system of claim 1, wherein the mesh screen is made from a UV-resistant polymer to improve longevity under sun exposure.

11. The system of claim 1, further comprising a low-profile floor plate that aligns and anchors the bottom magnetic seal.

12. The system of claim 1, wherein the vertical magnetic strips include staggered polarity sections to increase magnetic hold strength.

13. The system of claim 1, further comprising a detachable mounting system that allows seasonal removal of the screen mesh.

14. The system of claim 1, wherein the mesh screen features decorative patterning or color options to match home decor.

15. The system of claim 1, wherein the mesh screen is treated with an anti-microbial or anti-mildew coating.

16. The system of claim 1, further comprising a modular extension kit for adjusting screen size to fit various door frame dimensions.

17. The system of claim 1, wherein the mesh screen includes an optional translucent privacy band across the central section.

18. The system of claim 1, further comprising integrated corner guards made from thermoplastic or rubber to reduce corner wear.

19. The system of claim 1, wherein the system includes an installation kit comprising mounting hardware, adhesives, and a trimming tool.

20. A method of installing the system of claim 1, comprising the steps of aligning the frame into a standard sliding door track, securing the magnetic mesh screen into the frame, and optionally installing a floor plate and zipper components.
